(19) United States
(12) Patent Application Publication
(10) Pub. No.: US 2026/0017796 A1
(43) Pub. Date: Jan. 15, 2026

(54) CLASSIFICATION ASSISTING DEVICE, CLASSIFICATION ASSISTING METHOD, AND RECORDING MEDIUM

(71) Applicant: CASIO COMPUTER CO., LTD., Tokyo (JP)

(72) Inventor: Yasushi MAENO, Tokyo (JP)

(73) Assignee: CASIO COMPUTER CO., LTD., Tokyo (JP)

(21) Appl. No.: 19/259,045

(22) Filed: Jul. 3, 2025

(30) Foreign Application Priority Data
Jul. 12, 2024 (JP) 2024-112631

(51) Int. Cl. G06T 7/00; G06T 11/20; G06V 10/764

(52) U.S. Cl. CPC G06T 7/0016; G06T 11/206; G06V 10/764; G06T 2207/30088; G06T 2207/30096; G06T 2210/62; G06V 2201/03

(57) ABSTRACT

To display information in a coordinate system having a plurality of axes, based on chronological change values of a plurality of pieces of predetermined diagnosis region information. A classification assisting device includes one or more processors acquiring a chronological change value of each of a plurality of feature amounts relating to a diagnosis region, based on a plurality of diagnosis region images imaged at times different from each other and displaying a scatter diagram in which the chronological change value to be assigned to a first axis and the chronological change value to be assigned to a second axis are selected from the plurality of feature amounts.

### CROSS-REFERENCE TO RELATED APPLICATIONS

This application claims the benefit of Japanese Patent Application No. 2024-112631, filed on Jul. 12, 2024, the entire disclosure of which is incorporated by reference herein.

### FIELD OF THE INVENTION

This application relates to a classification assisting device, a classification assisting method, and a recording medium.

### BACKGROUND OF THE INVENTION

Conventionally, technologies to diagnose whether a tumor in a living body is benign or malignant have been developed. For example, a technology is known that detects feature points of a tumor in a living body from biological images and monitors a progression state of color and size of the tumor over time. However, when diagnosing the state of a disease, it is rare to diagnose the state of the disease, based on a single indicator such as color or size of the tumor in the living body, and a method for diagnosing a degree of progression and a degree of risk of the tumor in the living body, based on more complex indicators has been required. For example, Patent Literature 1 (Unexamined Japanese Patent Application Publication No. 2012-147930) discloses an image processing device for medical use that is capable of improving the precision of identification of cancerization of a tumor candidate through identification of the tumor candidate, calculation of mode information and function information, and calculation of a cancerization feature amount.

### SUMMARY OF THE INVENTION

However, the conventional technology disclosed in Patent Literature 1 does not comprehensively visualize a risk of each tumor by use of a plurality of indicators in combination, and there has been room for improvement in developing a user interface that displays information on an as-needed basis for a doctor (such as displaying a degree of change in progression of each tumor in a visually easily understandable manner).

The present disclosure has been made in consideration of the above-described circumstances, and an objective of the present disclosure is to provide a classification assisting device, a classification assisting method, and a non-transitory recording medium capable of displaying information in a coordinate system having a plurality of axes, based on chronological change values of a plurality of pieces of predetermined diagnosis region information.

In order to achieve the above-described objective, a classification assisting device according to the present disclosure includes:
one or more processors
acquiring a chronological change value of each of a plurality of feature amounts relating to a diagnosis region, based on a plurality of diagnosis region images imaged at times different from each other, and
displaying a scatter diagram in which the chronological change value to be assigned to a first axis and the chronological change value to be assigned to a second axis are selected from the plurality of feature amounts.

According to the present disclosure, it is possible to display information in a coordinate system having a plurality of axes, based on chronological change values of a plurality of pieces of predetermined diagnosis region information.

### BRIEF DESCRIPTION OF DRAWINGS

A more complete understanding of this application can be obtained when the following detailed description is considered in conjunction with the following drawings, in which:

FIG. 1 is a block diagram illustrating a functional configuration of a classification assisting device according to an embodiment;

FIG. 2 is a diagram illustrating an example of an image database;

FIG. 3 is a flowchart of classification assisting processing according to the embodiment;

FIG. 4 is a diagram illustrating an example of past image data;

FIG. 5 is a diagram illustrating an example of a diagnosis region database;

FIG. 6 is a diagram illustrating an example of current image data;

FIG. 7 is a diagram for a description of a correspondence between the past image and the current image;

FIG. 8 is a diagram illustrating an example of correspondence relation data;

FIG. 9 is a diagram for a description of correction of the past image based on the current image;

FIG. 10 is a diagram illustrating an example of a chronological change value database;

FIG. 11 is a diagram illustrating an example of a scatter diagram in which dots are arranged as plot points and an example of an enlarged view of diagnosis region images;

FIG. 12 is a diagram for a description of magnitude of a degree of risk in the scatter diagram;

FIG. 13 is a diagram illustrating an example of a scatter diagram in which current diagnosis region images are arranged as plot points;

FIG. 14 is a diagram illustrating an example of a scatter diagram in which pairs of a past diagnosis region image and a current diagnosis region image are arranged as plot points; and

FIG. 15 is a diagram illustrating an example of a display screen in which display axis setting and imaging date setting can be performed.

### DETAILED DESCRIPTION OF THE INVENTION

A classification assisting device and the like according to an embodiment are described below with reference to the drawings. Note that the same or corresponding parts in the drawings are designated by the same reference numerals.

A classification assisting device 100 according to the embodiment is a device that displays magnitude of chronological change in images indicating a diagnosis region (for example, images of a skin tumor) in a visually easily understandable manner. The classification assisting device 100, for example, images dermoscopy images, which are used at the time of examination by a dermatologist, at a plurality of times and displays magnitude of chronological change in diagnosis region information in the images in a visually easily understandable manner. Because of this configuration, it becomes easier for a user (a doctor or the like) to grasp a degree of risk or the like of a diagnosis region of a patient than ever before. Note that the diagnosis region includes not only a part (for example, a skin section) indicating a change in a living body (lesion) caused by a disease but also a part indicating a symptomatic change before becoming ill. In other words, all parts that the doctor attempts to diagnose (diagnosis sites) are included in the diagnosis regions, regardless of a stage of disease progression and including a part where whether or not the part has become ill is unclear. In addition, the diagnosis region information is various types of information indicating characteristics of the diagnosis region and is feature amounts, such as size, color, and a degree of malignancy (a probability of being malignant), of the diagnosis region.

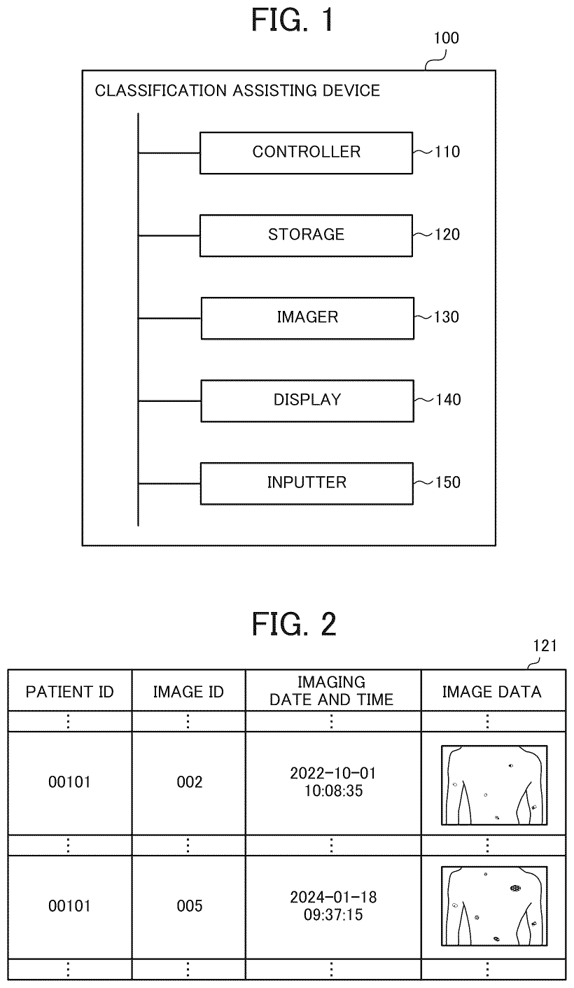

The classification assisting device 100 includes, as functional constituent elements, a controller 110, a storage 120, an imager 130, a display 140, and an inputter 150, as illustrated in FIG. 1.

The controller 110 includes a processor, such as a central processing unit (CPU). The controller 110 executes, by programs stored in the storage 120, classification assisting processing and the like, which are described later.

The storage 120 includes, for example, a random access memory (RAM), a read only memory (ROM), and a flash memory and stores the programs that the controller 110 executes and necessary data.

The imager 130 includes an imaging element, such as a complementary metal oxide semiconductor (CMOS) image sensor and a charge coupled device (CCD) image sensor. The imager 130 images, for example, the skin of a patient and acquires image data of the skin. The controller 110 acquires, based on, for example, an imaging instruction from the user, image data of the skin of the patient by the imager 130 and stores the acquired image data in the storage 120 in conjunction with an imaging date and time. Because of this configuration, in the storage 120, an image database 121 that stores the image data obtained by imaging the skin of a patient identified by a patient identification (ID) by the imager 130 in conjunction with the patient ID, an image ID, and an imaging date and time, as illustrated in, for example, FIG. 2 is constructed.

The display 140 includes a display device, such as a liquid crystal display and an organic electro luminescence (EL) display. The display 140 displays an image imaged by the imager 130, a scatter diagram, which is described later, and the like.

The inputter 150 is a user interface, such as a keyboard, a mouse, and a touch panel, and accepts operation input from the user. When the inputter 150 includes a touch panel, the inputter 150 may be a touch panel integrated with the display device in the display 140.

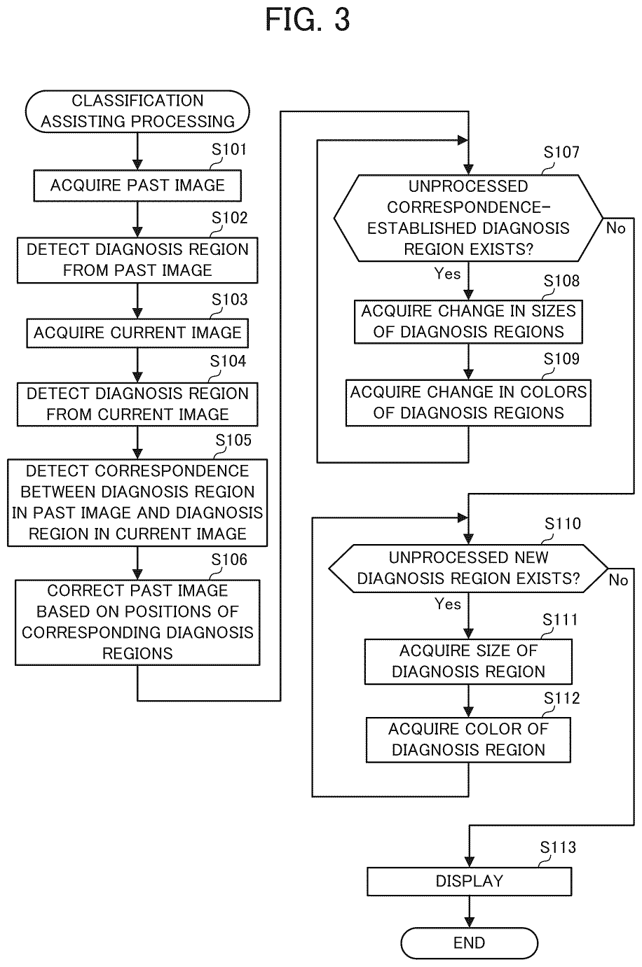

The functional configuration of the classification assisting device 100 is described above. The controller 110 detects a diagnosis region from image data imaged by the imager 130 and displays a scatter diagram in which each of values of chronological changes in a plurality of feature amounts (for example, size, color, and the degree of malignancy) relating to the diagnosis region is assigned to a different axis. The classification assisting processing that is processing for the controller 110 to perform the above-described operation is described with reference to FIG. 3. Execution of the processing is started by an instruction from the user. For example, when the user desires to cause a scatter diagram based on diagnosis region images to be displayed, the user causes the classification assisting device 100 to execute the present processing. Note that it is assumed herein that before the classification assisting processing is executed, past image data of the skin of a patient or the like are stored in the storage 120 as the image database 121 in advance. For example, the patient has the skin imaged when the patient has a regular physical examination, and the imaged image data are stored in the image database 121.

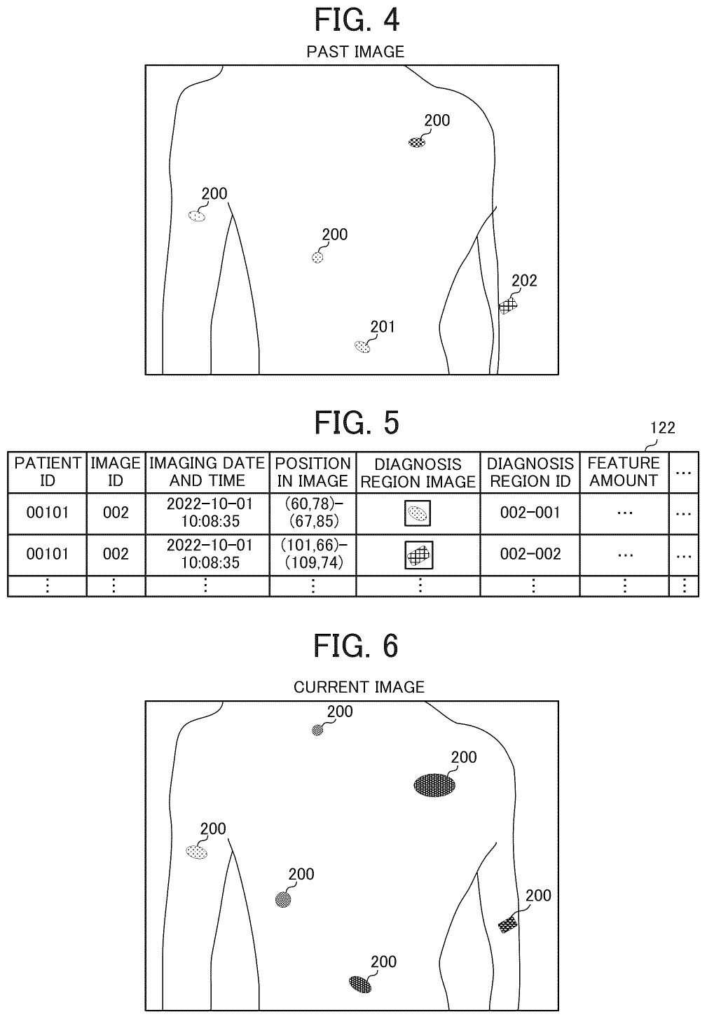

First, the controller 110 acquires past image data from the storage 120 (step S101). In this step, the controller 110 acquires image data as illustrated in, for example, FIG. 4. Next, the controller 110 detects diagnosis regions 200, 201, and 202 from the past image data (step S102). Subsequently, the controller 110 stores images of the detected diagnosis regions 200, 201, and 202 in the storage 120 as a diagnosis region database 122, as illustrated in FIG. 5, where each image is associated with a patient ID, an image ID, an imaging date and time, a position in the entire image (xy coordinates of an upper left corner and xy coordinates of a lower right corner of a rectangular region from which the corresponding diagnosis region is extracted), a diagnosis region ID (in FIG. 5, an ID obtained by adding the ID of the diagnosis region included in the image to the image ID), and feature amounts (size, a value of color, the degree of malignancy, and the like, which are described later). However, some or all of the feature amounts may be calculated in step S102 or calculated in and after step S108, which is described later. In the example illustrated in FIG. 5, it is revealed that the diagnosis region 201 in the image data illustrated in FIG. 4 is detected as a diagnosis region with a diagnosis region ID of 002-001 and the diagnosis region 202 in the same image data is detected as a diagnosis region with a diagnosis region ID of 002-002. Although any method can be used as a detection method for the diagnosis regions 200, 201, and 202, some methods are described below.

Examples of the detection method include, for example, a method including the following three steps, as a first method.

Step 1: image data (entire image) is converted into a grayscale image, the grayscale image is binarized with a threshold value, and closed curves are detected based on boundaries of the binarized values.

Step 2: the processing in step 1 is repeatedly performed changing the threshold value used when the grayscale image is binarized, and obtained closed curves are classified into groups each of which includes closed curves the central coordinates of which are close to each other.

Step 3: median values of center positions and sizes of each group are calculated and defined as a position and size of a corresponding diagnosis region, respectively.

In addition, examples of the detection method include a method using an object detection model, such as region-convolutional neural network (R-CNN) and you only look once (YOLO), as a second method.

Note, however, that the above-described methods are only examples and the detection method for the diagnosis regions 200, 201, and 202 is not limited to the above-described two methods.

Next, the controller 110 acquires current image data from the storage 120 or the imager 130 (step S103). In this step, the controller 110 acquires current image data (for example, a current image as illustrated in FIG. 6), which is slightly different from a past image data (for example, a past image as illustrated in FIG. 4). Next, the controller 110 detects diagnosis regions 200 from the current image data (step S104). A detection method for the diagnosis regions 200 in step S104 is the same as the detection method in step S102, and information about the diagnosis regions 200 detected in step S104 are also additionally recorded in the diagnosis region database 122.

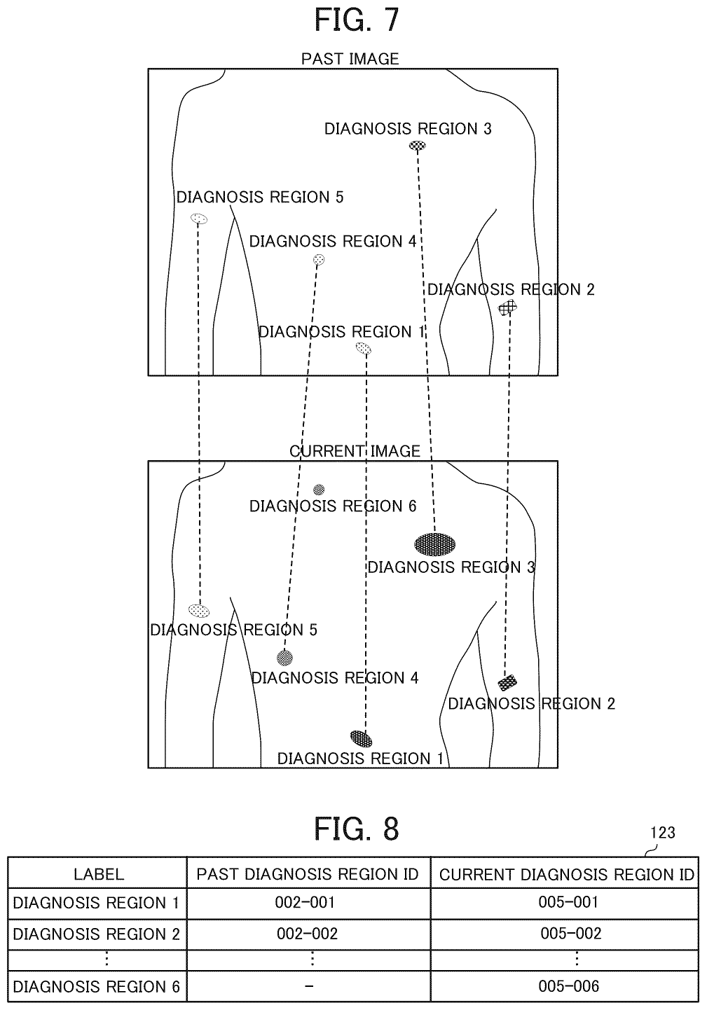

Next, the controller 110 detects correspondences between diagnosis regions in the past image and diagnosis regions in the current image, as illustrated by dashed lines in FIG. 7 (step S105). Although any method can be used as a detection method for a correspondence between diagnosis regions, a method of calculating a feature amount of an image with respect to each diagnosis region and establishing a correspondence between diagnosis regions having feature amounts that are close to each other in distance is conceivable as an example. In addition, as for diagnosis regions the correspondence between which cannot be established by the feature amounts of the images, a method of establishing a correspondence between diagnosis regions having centroid positions that are close to each other is conceivable. Establishing a correspondence between diagnosis regions having centroid positions that are close to each other enables a correspondence to be established even when distance between feature amounts of images is large, such as when change in the color or size between diagnosis regions of the past image and the current image is significant. In addition, rather than establishing a correspondence in two steps as described above (after establishing a correspondence using feature amounts of images, establishing a correspondence using centroid positions), a correspondence between diagnosis regions having feature amounts that are close in distance may be established using feature amounts that include not only feature amounts of the images but also the coordinates of the centroid positions as the feature amounts to be used when detecting the correspondence. With this method, there is a higher likelihood that a correct correspondence can be established in one step even when there are significant changes in the colors and sizes of the diagnosis regions.

Note that, the controller 110 recognizes a diagnosis region in the current image the correspondence of which with a diagnosis region in the past image cannot be established in step S105 as a diagnosis region that has newly appeared (new diagnosis region).

For example, Diagnosis Region 6 in the current image in FIG. 7 is recognized as a new diagnosis region. The controller 110 stores a correspondence relation detected in step S105 in the storage 120 as correspondence relation data 123 as illustrated in FIG. 8. “Label” illustrated in FIG. 8 is a label used when each diagnosis region is indicated to the user (a label is, for example, displayed in a vicinity of a plot point of each diagnosis region when a scatter diagram is displayed by the display 140), and although in this example, labels are automatically set as “Diagnosis Region 1”, “Diagnosis Region 2”, and so on in ascending order of the current diagnosis region ID (a remaining part of the diagnosis region ID after removing an image ID), the user may freely set the labels. As Diagnosis Regions 1 to 5 illustrated in FIG. 7, a diagnosis region where a correspondence between the past image data and the current image data is established (a diagnosis region where both the past diagnosis region ID and the current diagnosis region ID exist in the correspondence relation data 123) is referred to as a correspondence-established diagnosis region, and a diagnosis region that, although not existing in the past image data, exists in the current image data (a diagnosis region where only the current diagnosis region ID exists in the correspondence relation data 123), as Diagnosis Region 6 illustrated in FIG. 7, is referred to as a new diagnosis region.

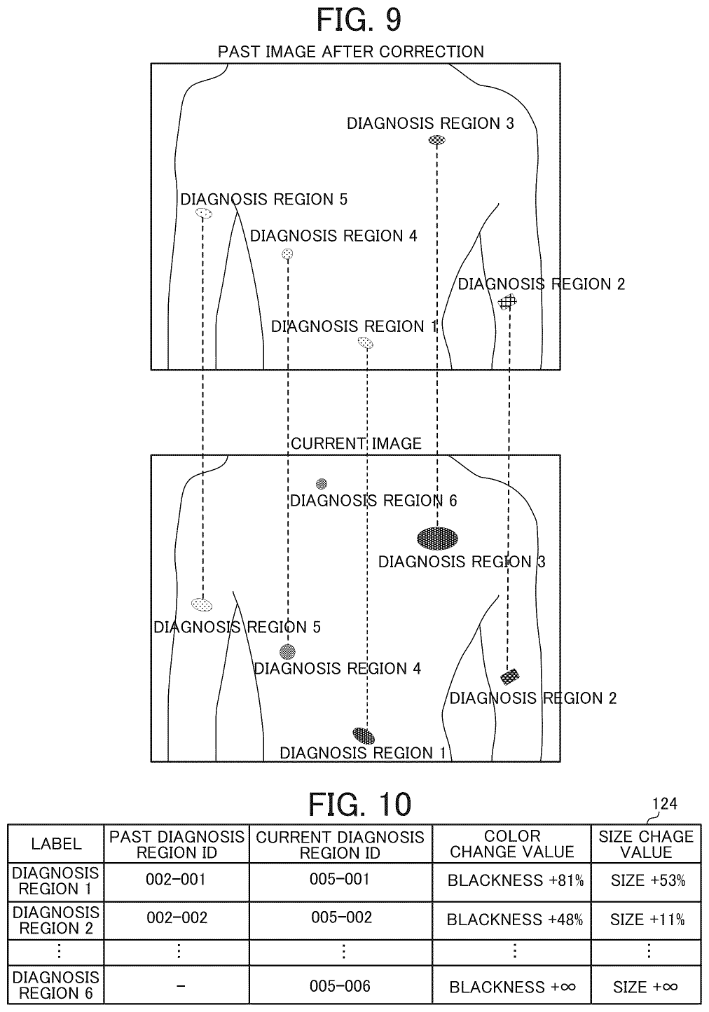

Next, the controller 110 corrects the past image data, based on the positions of the corresponding diagnosis regions (step S106). In this step, the controller 110 corrects (deforms) the past image data in such a way that a position of each diagnosis region in the past image data coincides with a position of a corresponding diagnosis region in the current image data, as illustrated in FIG. 9. Although the correction of image data is performed in any manner, for example, a morphological transformation can be used. By making a correction to the past image data in this way, it becomes easier to detect changes in the sizes of the diagnosis regions between the past image data and the current image data and also becomes easier to confirm whether or not the correspondence is established correctly. Note that the controller 110 may detect changes in the sizes of the diagnosis regions, based on the image database 121, the diagnosis region database 122, the correspondence relation data 123, and the like stored in storage 120 without correcting the past image data, and in this case, the controller 110 does not have to perform the processing in step S106.

Next, the controller 110 determines whether or not there is any correspondence-established diagnosis region for which processing in steps S108 and S109, which is described later, has not been performed (unprocessed correspondence-established diagnosis region) (step S107). When there is no unprocessed correspondence-established diagnosis region (step S107; No), the process proceeds to step S110. When there is an unprocessed correspondence-established diagnosis region (step S107; Yes), the controller 110 selects one from unprocessed correspondence-established diagnosis regions and acquires the magnitude of change in the size of the correspondence-established diagnosis region (a size change value) (step S108). Although any method can be used as a method for acquiring a size change value of a correspondence-established diagnosis region, the size change value of the correspondence-established diagnosis region is acquired, for example, by calculating the size of the correspondence-established diagnosis region in the past image data and the size of the correspondence-established diagnosis region in the current image data and calculating a ratio of the sizes ((the size of the current correspondence-established diagnosis region)/(the size of the past correspondence-established diagnosis region)). Note that the controller 110 may calculate, instead of a ratio, a difference between the sizes ((the size of the current correspondence-established diagnosis region)−(the size of the past correspondence-established diagnosis region)) as the size change value of the correspondence-established diagnosis region. Although any method can also be used as a method for calculating the size of a correspondence-established diagnosis region, examples of the method include a method of calculating the size of a correspondence-established diagnosis region by counting the number of pixels the pixel values of which are distinct (to the extent that the pixels can be determined to be included in the diagnosis region) in an area including the diagnosis region in the image data. Subsequently, the controller 110 stores the calculated size in the diagnosis region database 122 in the storage 120 as one of the feature amounts of the correspondence-established diagnosis region in association with the image of the correspondence-established diagnosis region, and stores the calculated size change value in the chronological change value database 124 as illustrated in FIG. 10.

Next, the controller 110 acquires magnitude of color change (a color change value) of the correspondence-established diagnosis region (step S109), and returns to step S107. Although any method can also be used as a method for acquiring a color change value of a correspondence-established diagnosis region, the color change value of the correspondence-established diagnosis region is acquired, for example, by calculating blackness of the correspondence-established diagnosis region in the past image data and blackness of the correspondence-established diagnosis region in the current image data and calculating a difference between the values of blackness ((the blackness of the current correspondence-established diagnosis region)−(the blackness of the past correspondence-established diagnosis region)). Note that the controller 110 may calculate, instead of a difference, a ratio of the values of blackness ((the blackness of the current correspondence-established diagnosis region)/(the blackness of the past correspondence-established diagnosis region)) as the color change value of the correspondence-established diagnosis region. Although any method can also be used as a method for calculating blackness, examples of the method include a method of calculating, based on a median value (R1, G1, B1) of RGB (Red Green Blue) values of pixels belonging to an area considered to be a diagnosis region and a median value (Rs, Gs, Bs) of RGB values of pixels in a skin area considered not to be the diagnosis region, a luminance value Yl of the diagnosis region and a luminance value Ys of the skin area and calculating blackness expressed by (Ys−Yl)/Ys. In this configuration, the luminance value Y can be calculated by Y=0.299×R+0.578×G+0.114×B, using an RGB value. Subsequently, the controller 110 stores the calculated blackness in the diagnosis region database 122 in the storage 120 as one of the feature amounts of the correspondence-established diagnosis region in association with the image of the correspondence-established diagnosis region, and stores the calculated color change value in the chronological change value database 124.

In step S110, the controller 110 determines whether or not there is any new diagnosis region for which processing in steps S111 and S112, which is described later, has not been performed (unprocessed new diagnosis region). When there is no unprocessed new diagnosis region (step S110; No), the process proceeds to step S113. When there is an unprocessed new diagnosis region (step S110; Yes), the controller 110 selects one from unprocessed new diagnosis regions and acquires size of the new diagnosis region (step S111). A method for acquiring the size of the new diagnosis region is the same as the method for calculating the size of the correspondence-established diagnosis region in step S108 described above. Subsequently, the controller 110 stores the acquired size in the diagnosis region database 122 in the storage 120 as one of feature amounts of the new diagnosis region in association with an image of the new diagnosis region. Note that although as for the new diagnosis region, a size change value cannot be calculated in the strict sense, in the example illustrated in FIG. 10, the size of a past diagnosis region is assumed to be 0 and the size change value is stored as +∞ in the chronological change value database 124.

Next, the controller 110 acquires a value of color of the new diagnosis region (step S112), and returns to step S110. A method for acquiring the value of the color of the new diagnosis region is the same as the method for calculating blackness in step S109 described above. Subsequently, the controller 110 stores the acquired blackness (the value of the color) in the diagnosis region database 122 in the storage 120 as one of the feature amounts of the new diagnosis region in association with the image of the new diagnosis region. Note that although as for a new diagnosis region, a color change value cannot be calculated in the strict sense, in the example illustrated in FIG. 10, the value of the color of a past diagnosis region is assumed to be 0 and the color change value is stored as +∞ in the chronological change value database 124. In addition, the controller 110 may be configured to estimate chronological change values, such as a size change value and a color change value, from only the new diagnosis region by using, for example, a deep neural network (DNN) trained with a vast amount of image data and store the estimated chronological change values in the chronological change value database 124.

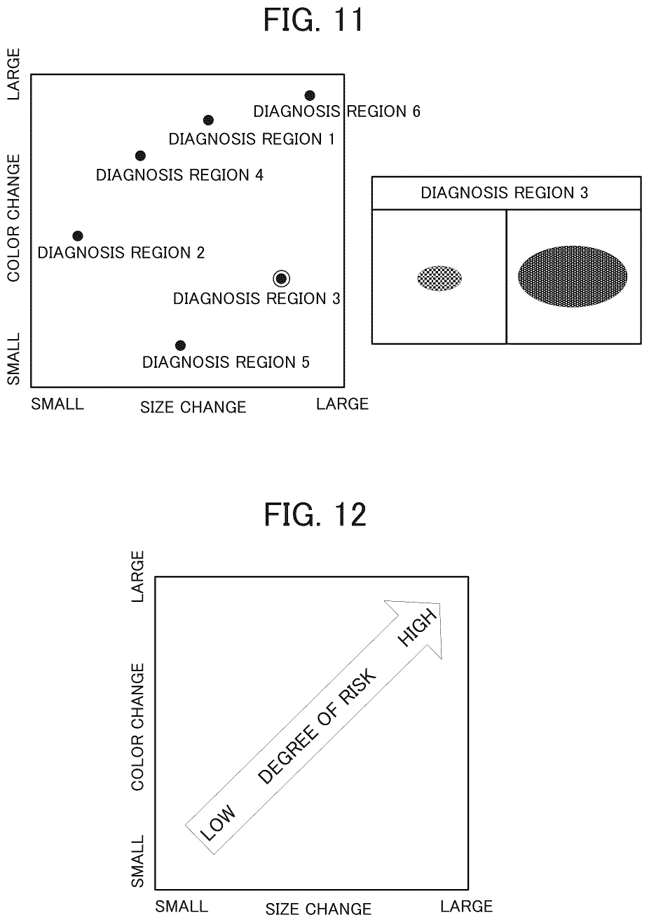

In step S113, the controller 110 displays the diagnosis regions in a scatter diagram as illustrated in FIG. 11 by arranging plot points at positions based on the size change values and the color change values of the correspondence-established diagnosis regions acquired up to that time and the values of the size and color of the new diagnosis region, and terminates the classification assisting processing. In the example illustrated in FIG. 11, the size change value and the color change value are assigned to the abscissa and the ordinate, respectively. Note, however, that as for the new diagnosis region, the size change value and color change value are defined assuming that past size and color values are 0. In this case, since although there is no problem when a change value is calculated by a difference, calculating the change value by a ratio causes a numerator to be divided by zero, it is assumed that when the change value is defined as a ratio, the size change value and the color change value of the new diagnosis region have maximum values in the scatter diagram.

In addition, in the example illustrated in FIG. 11, when the user selects one of the diagnosis regions plotted on the scatter diagram by clicking or the like, the controller 110 is configured to display enlarged views of the past image and the current image of the selected diagnosis region in such a way that the past image and current image of the selected diagnosis region can be compared with each other. FIG. 11 is an example of a case where Diagnosis Region 3 is selected.

Since through the classification assisting processing described above, the classification assisting device 100 displays a scatter diagram by assigning chronological change values of feature amounts relating to a diagnosis region, such as a size change value and a color change value, to the first and second axes of the scatter diagram, respectively, information can be displayed in a coordinate system with a plurality of axes, based on the chronological change values of a plurality of pieces of predetermined diagnosis region information. This display enables visualization of an objective diagnosis result of a tumor in a living body and presentation of a risk of the tumor.

Since it is considered that the larger the size of a diagnosis region becomes and the darker the color of the diagnosis region becomes (the higher the blackness becomes), the higher a risk becomes, the larger the size change value and the color change value are (the further the diagnosis region is located on the upper right side of the scatter diagram), the higher the degree of risk of the diagnosis region becomes, as illustrated by FIG. 12. In an examination of a diagnosis region, a diagnosis region with a higher degree of risk has a higher degree of importance.

Therefore, a person who checks diagnosis regions (such as a doctor) is only required to check a diagnosis region located on the upper right side of the scatter diagram in a preferential manner among many diagnosis regions. Note that it may be configured such that a value obtained by performing a weighted addition of the size change value and the color change value or a value obtained by performing a weighted multiplication of the size change value and the color change value is calculated as a value of the degree of risk and the value of the degree of risk is displayed in a vicinity of each plot point in the scatter diagram.

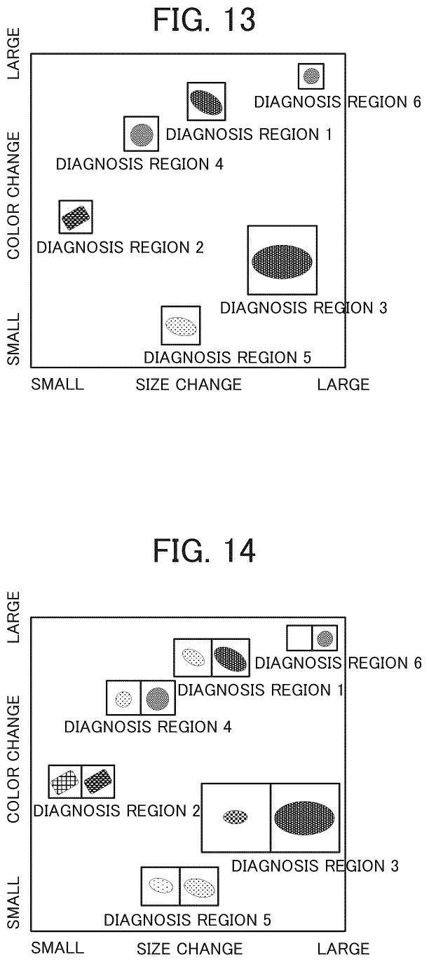

In addition, although in FIG. 11, an example in which by selecting a plot point in the scatter diagram, diagnosis region images are displayed is illustrated, the controller 110 may display, as illustrated in FIG. 13, a scatter diagram in which each diagnosis region image is arranged as a plot point. By arranging the diagnosis region images as plot points, the user can simultaneously grasp the images and the degrees of risk of the diagnosis regions and perform a more efficient diagnosis. Note that although in FIG. 13, the current diagnosis region images are arranged as plot points, the past diagnosis region images may also be arranged as plot points, or whether the current diagnosis region images or the past diagnosis region images are used as images to be arranged as plot points may be switched based on an instruction from the user or at a predetermined interval (for example, every second).

In addition, the controller 110 may arrange, as plot points, images each of which is composed of a pair of a past diagnosis region image and a current diagnosis region image arranged in line, as illustrated in FIG. 14. Because of this configuration, compared with the case where only a current diagnosis region image or a past diagnosis region image is arranged as a plot point, it becomes easier for the user to grasp changes in the diagnosis regions. In addition, although in FIG. 14, each pair of a past diagnosis region image and a current diagnosis region image are displayed side by side, the pair of the past diagnosis region image and the current diagnosis region image may also be displayed in a superimposing manner (the past diagnosis region image and the current diagnosis region image may be superimposed on each other). Because of this configuration, it becomes easier for the user to grasp changes in the size and shape of each diagnosis region. Further, when the past diagnosis region image and the current diagnosis region image are superimposed on each other, transparency in the superimposition may be changed in such a manner that the longer a time difference between the past time point and the current time point is, the higher the transparency is made (the longer an elapsed time from the reference time point to the diagnosis time point is, the lighter the display of the past diagnosis region image is made). Because of this configuration, the user is facilitated to intuitively grasp the length of a period (elapsed time) from the reference time point to the diagnosis time point.

In addition, although in FIGS. 13 and 14, a frame line of a rectangle displayed at the time of displaying a diagnosis region image is illustrated in black, the frame line of the rectangle displayed at the time of displaying the diagnosis region image may be displayed in different colors according to a type and property of skin disease related to the diagnosis region, the magnitude of change values of feature amounts (for example, color, size, the degree of malignancy, and the like), and the like. Because of this configuration, the user becomes capable of grasping various information relating to each diagnosis region that a scatter diagram cannot directly represent, from the color of the frame line. Note that the color of a frame line referred to in the above description is only an example, and in substitution for the color of the frame line or in conjunction with the color of the frame line, background color of a diagnosis region image may be changed to different colors. In addition, in place of the color of the frame line or in conjunction with the color of the frame line, a mode of the frame line (a solid line, a dashed line, a dashed-dotted line, a dotted line, or the like) may be changed according to the type and property of skin disease related to the diagnosis region, the magnitude of change values of feature amounts (for example, color, size, the degree of malignancy, and the like), and the like.

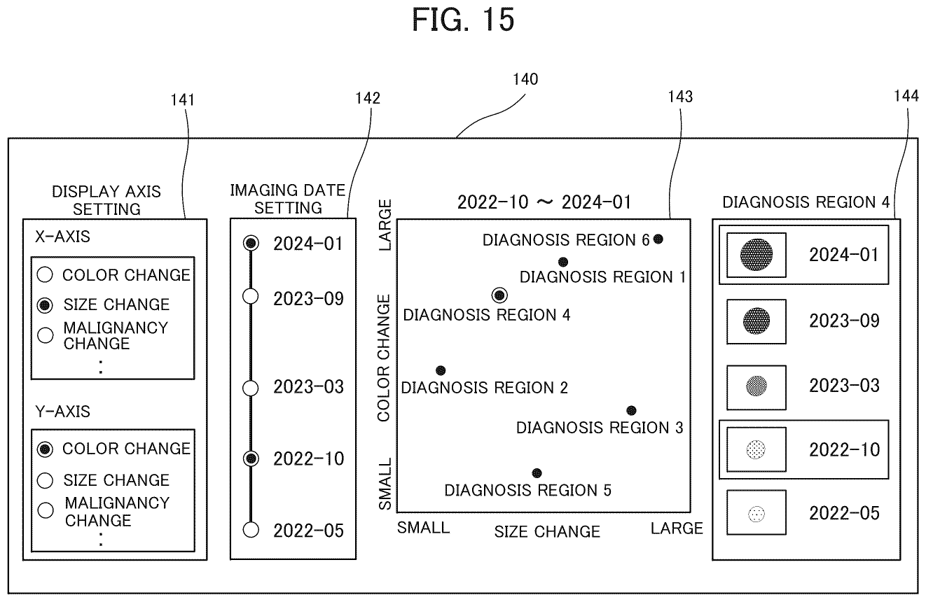

Note that although in the description of the above-described classification assisting processing (FIG. 3), the description is made assuming that to the respective axes of the scatter diagram, the size change value and the color change value are assigned as chronological change values of a plurality of feature amounts relating to a diagnosis region, feature amounts relating to a diagnosis region are not necessarily limited to size and color. A chronological change value of any feature amount relating to the diagnosis region can be assigned to either axis of the scatter diagram as long as the feature amount indicates that the larger the chronological change value of the feature amount is, the higher the degree of risk of the diagnosis region increases. For example, the controller 110 may calculate degrees of malignancy from images of each of the diagnosis regions, calculates a change value of the degree of malignancy, based on the degree of malignancy of the diagnosis region from the past image and the degree of malignancy of the current diagnosis region (for example, based on “(current degree of malignancy)/(past degree of malignancy)” or “(current degree of malignancy)−(past degree of malignancy)”), and assign the change value of the degree of malignancy to one of the axes of the scatter diagram. Although any method can be used as a method for calculating the degree of malignancy, the degree of malignancy can be calculated using, for example, a benign-malignant classifier obtained by training a deep learning model with a large number of malignant diagnosis region images and benign diagnosis region images prepared in advance. In addition, the change value of which feature amount is assigned to each of an X-axis and a Y-axis may be configured to be settable, as illustrated by, for example, a display axis setting 141 in FIG. 15. As described above, by generating a scatter diagram through selection of a plurality of types of feature amounts the chronological change value of which is to be calculated, from size, color, the degree of malignancy, and the like, the user becomes capable of determining the degree of risk of a diagnosis region from more perspectives.

In addition, although not illustrated, a three-dimensional scatter diagram may be configured to be constructed by preparing three axes, namely the X-axis, the Y-axis, and the Z-axis, as the axes of the scatter diagram and assigning, to each of the three axes, one of chronological change values of three types of feature amounts (such as a size change value, a color change value, and a change value of the degree of malignancy). By using a three-dimensional scatter diagram based on a chronological change value (for example, the size change value) assigned to the first axis, a chronological change value (for example, the color change value) assigned to the second axis, and a chronological change value (for example, a change value of the degree of malignancy) assigned to the third axis in this way, the user becomes capable of grasping the chronological change values of three types of feature amounts at once, which enables determination of the degree of risk of a diagnosis region from many perspectives to be performed in a more efficient manner.

In addition, although in the above description, two images at the time of determining a chronological change value are referred to as a past image and a current image, both imaging times of the past image and the current image are still time points in the past with reference to a time point when the scatter diagram is displayed. It can be said that the past image in the above description is an image serving as a reference for calculating the magnitude of a chronological change value and the current image is a target image to be diagnosed. Therefore, the imaging time of the past image is also referred to as a reference time, and the imaging time of the current image is also referred to as a diagnosis time. Since the reference time, which is the imaging time (imaging date) of the past image, and the diagnosis time, which is the imaging time of the current image, may be arbitrary times as long as the reference time and the diagnosis time are different from each other, it may be configured such that, as illustrated by, for example, an imaging date setting 142 in FIG. 15, two imaging dates are selectable from image data stored in the storage 120. Although in the example illustrated in FIG. 15, October 2022 and January 2024 are selected, in this case, October 2022 that is an earlier time than the other of the two times is set as the reference time, and January 2024 that is a time closer to the current time than the other is set as the diagnosis time. A scatter diagram 143 is displayed based on the change values of the feature amounts (in FIG. 15, the size change value and the color change value) between the diagnosis region images in October 2022 and the diagnosis region images in January 2024.

Since plot points in the scatter diagram 143 are arranged based on the magnitude of chronological change values of the feature amounts set in the display axis setting 141, modifying the reference time or the diagnosis time in the imaging date setting 142 causes the chronological change values to change accordingly and positions at which the plot points are arranged to be also changed. Therefore, based on changes in the arrangement of the respective diagnosis regions, which changes depending on settings in the imaging date setting 142, the user can grasp change in the degree of risk of each diagnosis region matching the time. Further, since by selecting one of the diagnosis regions (in FIG. 15, Diagnosis Region 4), the diagnosis region images of the diagnosis region at the respective times, which are stored in the storage 120, are displayed in a list in a display frame 144, the user can set the reference time and the diagnosis time while viewing the diagnosis region images at the respective times.

Although in the above description, the description is made assuming that the diagnosis region image is a diagnosis region image of skin disease, the diagnosis region image is not limited to a diagnosis region image of skin disease. The classification assisting device 100 is applicable to a diagnosis region image of any disease as long as the diagnosis region image is an image where magnitude of chronological change values of feature amounts relating to the diagnosis region is considered to be related to the degree of risk of the diagnosis region.

In addition, in the above-described embodiment, the description is made assuming that the classification assisting device 100 includes the imager 130 and the classification assisting device 100 alone can image a diagnosis region image of skin disease of the user. However, the classification assisting device 100 may have a configuration in which the imager 130 exists as a separate device from the classification assisting device 100. For example, it may be configured such that in a classification assisting system that includes a camera including an imager 130 and a classification assisting device having a configuration obtained by removing the imager 130 from the classification assisting device 100 (a camera-less classification assisting device), a controller 110 acquires a diagnosis region image and the like from the imager 130 in the camera and performs processing similar to the processing performed by the above-described classification assisting device 100.

In addition, the classification assisting device 100 may have a configuration in which the display 140 exists as a separate display device connected to the classification assisting device 100 (regardless of whether the connection is a wired connection or a wireless connection). As described above, the classification assisting device 100 does not need to have all of the constituent elements in a single housing, and may have a configuration in which any functional part (such as the imager 130, the display 140, and the inputter 150) exists as a separate entity as needed basis.

In addition, the classification assisting device 100 can also be achieved by a computer, such as a smartphone, a tablet, and a personal computer (PC). Specifically, in the above-described embodiment, the description is made assuming that programs for the classification assisting processing and the like that the controller 110 executes are stored in advance in the storage 120. However, a computer capable of executing the above-described respective pieces of processing may be configured by storing programs in a non-transitory computer-readable recording medium, such as a flexible disk, a compact disc read only memory (CD-ROM), a digital versatile disc (DVD), a magneto-optical disc (MO), a memory card, and a USB memory, and distributing the recording medium and reading and installing the programs in the computer.

Further, it is also possible to superimpose a program on a carrier wave and apply the program via a communication medium, such as the Internet. For example, the program may be posted on a bulletin board system (BBS) on a communication network and distributed via the communication network. It may be configured such that the above-described processing can be executed by starting up and executing the distributed program in a similar manner to other application programs under the control of the operating system (OS).

In addition, the controller 110 may be configured by an arbitrary processor, such as a single processor, multiprocessors, and a multi-core processor, alone, by one or more of these arbitrary processors, or by combining one or more of these arbitrary processors with one or more processing circuits, such as an application specific integrated circuit (ASIC) and a field-programmable gate array (FPGA).

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

1. A classification assisting device, comprising
one or more processors
acquiring a chronological change value of each of a plurality of feature amounts relating to a diagnosis region, based on a plurality of diagnosis region images imaged at times different from each other, and
displaying a scatter diagram in which the chronological change value to be assigned to a first axis and the chronological change value to be assigned to a second axis are selected from the plurality of feature amounts.

2. The classification assisting device according to claim 1, wherein
the one or more processors
accept input of two times from among times at which the diagnosis region images are imaged,
set, of the accepted two times, an earlier time as a reference time and a time closer to a current time as a diagnosis time, and
acquire a value of change in feature amounts of the diagnosis region images from the reference time to the diagnosis time as the chronological change value.

3. The classification assisting device according to claim 1, wherein
the one or more processors
accept input of two feature amounts from among color, size, and a degree of malignancy, and
assign one of the accepted two feature amounts to the first axis and the other to the second axis.

4. The classification assisting device according to claim 1, wherein
the one or more processors
arrange the diagnosis region images in the scatter diagram as plot points.

5. The classification assisting device according to claim 2, wherein
the one or more processors
arrange a pair of images including the diagnosis region image at the reference time and the diagnosis region image at the diagnosis time in the scatter diagram as a plot point.

6. The classification assisting device according to claim 2, wherein
the one or more processors
arrange an image obtained by superimposing the diagnosis region image at the reference time on the diagnosis region image at the diagnosis time in the scatter diagram as a plot point.

7. The classification assisting device according to claim 6, wherein
the one or more processors
change transparency of the diagnosis region image at the reference time at a time of superimposing the diagnosis region image at the reference time on the diagnosis region image at the diagnosis time according to length of an elapsed time from the reference time to the diagnosis time.

8. The classification assisting device according to claim 1, wherein
the one or more processors
select the chronological change value to be further assigned to a third axis from the plurality of feature amounts, and
display a scatter diagram based on the chronological change value to be assigned to a first axis, the chronological change value to be assigned to a second axis, and the chronological change value to be assigned to a third axis.

9. A classification assisting method, comprising one or more processors:
acquiring a chronological change value of each of a plurality of feature amounts relating to a diagnosis region, based on a plurality of diagnosis region images imaged at times different from each other; and
displaying a scatter diagram in which the chronological change value to be assigned to a first axis and the chronological change value to be assigned to a second axis are selected from the plurality of feature amounts.

10. A non-transitory computer-readable recording medium recording a program to cause one or more processors to execute processing comprising:
acquiring a chronological change value of each of a plurality of feature amounts relating to a diagnosis region, based on a plurality of diagnosis region images imaged at times different from each other, and
displaying a scatter diagram in which the chronological change value to be assigned to a first axis and the chronological change value to be assigned to a second axis are selected from the plurality of feature amounts.
